(19) United States
(12) Patent Application Publication
(10) Pub. No.: US 2025/0200972 A1
(43) Pub. Date: Jun. 19, 2025

(54) Animal Trap Monitoring System

(71) Applicant: PestSense Holdings Pty Ltd, Brisbane (AU)

(72) Inventors: Dean Dobson, Brisbane (AU); Sam Donley, Brisbane (AU)

(21) Appl. No.: 18/846,366

(22) PCT Filed: Mar. 15, 2022
(86) PCT No.: PCT/AU2022/050215

§ 371 Date: Sep. 12, 2024

(51) Int. Cl. G06V 20/52; A01M 23/18; A01M 23/38; G06V 20/40; H04N 23/51; H04N 23/56; H04N 23/65; H04N 23/661

(52) U.S. Cl. CPC G06V 20/52; A01M 23/38; G06V 20/44; H04N 23/51; H04N 23/56; H04N 23/651; H04N 23/661; A01M 23/18

(57) ABSTRACT

The present disclosure provides an animal trap monitoring system that utilises paired sets of motion or activity sensing units, referred to as trap activation units, in close proximity to an animal trap, and camera units placed close by and in wireless communication with the trap activation units. Upon sensing motion or other indications of animal activity the trap activation sends an alert to its paired camera unit which triggers the capture of image date. The camera unit then uploads this image data and other relevant data to one or more servers hosting an online platform through which a user may access and view the image data.

### FIELD OF INVENTION

The present invention relates generally to trap monitoring systems. More specifically, the present invention relates to a camera unit configured to capture and upload image data of an animal trap to one or more servers in response to an alert from a paired trap activation unit.

### BACKGROUND

The monitoring of animal traps is often resource and labor intensive. Animal protection regulations require that such traps are checked regularly, and there are often large numbers of traps to be checked, with many of them in remote, inaccessible locations.

Some trap monitoring solutions known in the art send a signal to a remote operator when the trap is triggered, reducing the frequency with which the trap must be checked, however this still leads to wasted effort due to false alarms and animals species which are not of the target species being captured by the trap.

Other trap monitoring solutions utilize live video streaming of cameras installed on or nearby the traps to ensure that the trap is only checked when necessary and can be remotely opened and reset when a species that is not a target species is captured.

The issue with such solutions is the large amounts of wireless data upload required to perform such operations and the cost of units capable of this. When large numbers of traps are deployed the data requirements and cost of equipment become prohibitive. Another issue is that the camera angles for such solutions are usually unable to capture the approach of the animals to the trap, thus failing to capture useful information on pest behaviour.

It is within this context that the present invention is provided.

### SUMMARY

The present disclosure provides an animal trap monitoring system that utilises paired sets of motion or activity sensing units, referred to as trap activation units, in close proximity to an animal trap, and camera units placed close by and in wireless communication with the trap activation units. Upon sensing motion or other indications of animal activity the trap activation sends an alert to its paired camera unit which triggers the capture of image date. The camera unit then uploads this image data and other relevant data to one or more servers hosting an online platform through which a user may access and view the image data.

As the camera unit only needs to upload image data in response to a trigger from the trap activation unit, power and data consumption of the system are greatly reduced without any reduction in quality of the monitoring operation.

Thus, according to one aspect of the present disclosure there is provided a system for monitoring an animal trap, the system comprising: a camera unit, the camera unit comprising: a power source; a digital camera; a first wireless communications module; and a first controller; a trap activation unit, the trap activation unit comprising: a power source; one or more sensors; securing means for affixing the unit in place upon, or in close proximity to, an animal trap; a second wireless communications module; and a second controller paired with and in wireless communication with the first controller; and one or more servers configured to receive and store image data from the camera unit and further configured to host an online platform for interfacing with the camera unit via one or more user devices.

The second controller is configured to generate and send a notification or alert to the first controller in response to a detection of a signal from the one or more sensors indicative of animal activity; and the first controller is configured to, in response to receiving a notification or alert from the second controller, capture image data of an animal trap with the digital camera and upload the image data to the one or more servers.

In some embodiments, the one or more servers are configured to allow a user accessing the hosted online platform to remotely instruct the camera unit to capture image data and upload it to the platform for viewing on demand.

In some embodiments, the camera unit further comprises one or more additional sensors.

The additional sensors may include a motion sensor in the form of a vibration sensor and/or an infra-red, IR sensor, and the first controller may be configured to capture and upload image data in response to a detection of motion in proximity to the camera unit.

The additional sensors may also include a magnetic field sensor. The magnetic field sensor may be paired with a permanent magnet and the first controller may be configured to capture and upload image data in response to a detection of a change in magnetic field strength detected from the permanent magnet.

The one or more servers may be configured to allow a user accessing the platform to instruct the first controller on whether to trigger the capture of image data based on the trap activation sensor or using a sensor of the one or more additional sensors.

In some embodiments, the camera unit further comprises a flash lighting element configured to illuminate an area at which the digital camera is focused to facilitate capture of image data.

In some embodiments, the paired wireless communications modules of the camera unit and trap activation unit communicate via Bluetooth.

Furthermore, the wireless communications module of the camera unit may be configured for satellite and 4G wireless standards to communicate with the one or more servers.

In some embodiments, the camera unit further comprises a GPS unit, and is configured to upload location data to the one or more servers alongside the image data.

In some embodiments, the components of the camera unit are disposed within a waterproof housing.

In some embodiments, the camera unit comprises securing means for affixing it in place with a view of an animal trap and surrounding environment.

In some embodiments, the second controller is configured with one or more predefined thresholds and/or filter algorithms for preventing false alert notifications from being sent to the first controller.

In some embodiments, the one or more servers are configured to allow a user to remotely deactivate the camera unit, putting it into a low power sleep mode.

16. A system according to claim 1, wherein the system further comprises one or more additional pairs of camera units and trap activation units in communication with the one or more servers.

### BRIEF DESCRIPTION OF THE DRAWINGS

Various embodiments of the invention are disclosed in the following detailed description and accompanying drawings.

FIG. 1 illustrates an example system architecture for monitoring an animal trap according to the present disclosure.

FIG. 2 illustrates a paired camera unit and trap activation unit for monitoring an animal trap within the disclosed system.

FIG. 3 illustrates the paired camera unit and trap activation unit in the process of monitoring an animal trap.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a system for monitoring an animal trap using pairs of camera units and trap activation units in wireless communication with one another, for example through Bluetooth or Bluetooth Low Energy communication, and which upload captured image data to a network or cloud architecture for viewing by one or more user devices on an online platform. Users may also interface with the camera unit remotely in other ways via the platform.

The term “user” as used herein can apply to any individual accessing the disclosed platform over a network via one or more “user devices” by logging into their respective “user account”. User accounts may be divided into operator accounts and client accounts.

As discussed herein, the term “client account” generally refers to an account maintained on behalf of a client and through which they may view image data captured by and interface with one or more camera units owned by them that are monitoring animal traps in different locations.

Operators and administrators of the system may also have their own accounts on the platform with greater access rights to ensure functioning of the overall system, which will likely have a large number of camera units in various locations associated with different client accounts.

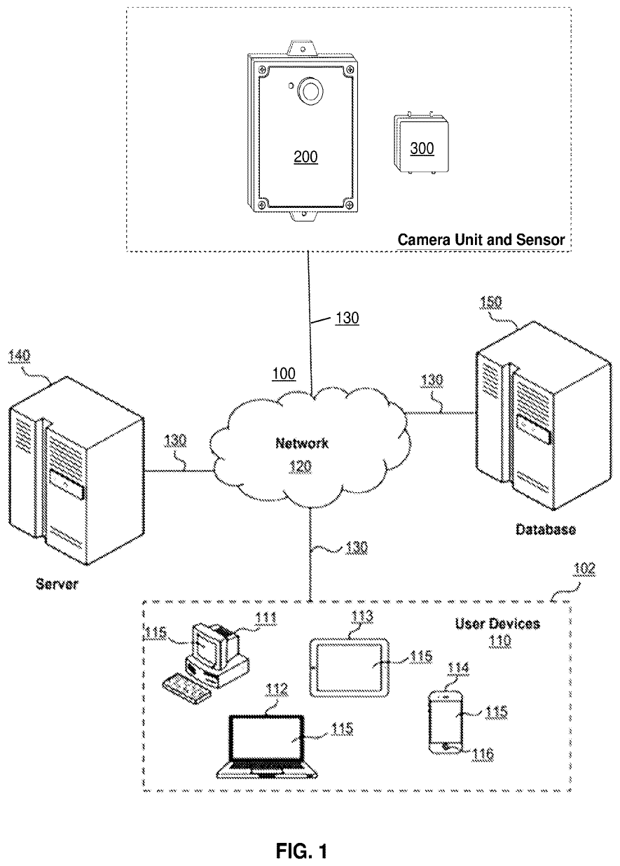

Referring now to FIG. 1, an exemplary embodiment of an Animal Monitoring Platform system 100 is shown. In this example, the Animal Monitoring Platform system 100 permits a user making use of a user device 110 to securely and rapidly interface with and access image data captured by a camera unit 200 paired with a corresponding trap activation unit 300.

In this example, each user device 110 shares a common user account 102. The user account 102 provides for convenient storing and sharing of account information for the same user between user devices 110, including the number and trap IDs of each trap associated with that user, etc. Of course, multiple other different user accounts are managed by the system.

Exemplary user devices 110 as may be used in the Animal Monitoring Platform system 100 include, without limitation, a personal computer (PC) 111, a laptop 112, a tablet computer 113, and smartphone 114.

Generally, each user device 110 includes a display 115 and/or one or more processors. Each of the display 115 offers the user a visual interface for interaction with the Animal Monitoring Platform system 100. For example, the Animal Monitoring Platform system 100 may be presented as a browser interface that makes use of known techniques for user interaction.

Each user device 110 is in communication with network 120 through communications channel 130. The camera units 200 are equipped to communicate with the network 120 by suitable wireless standards. The wireless communications standards include, by way of example and not of limitation, 4G, 5G, and satellite, CDMA, WCDMA, GSM, UMTS, or any other wireless communication system such as wireless local area network (WLAN), Wi-Fi or WiMAX. The camera units 200 are also equipped with short range wireless communications capabilities, i.e. Bluetooth, for communicating with their paired trap activation units 300. The network 120 is also in communication with server 140 and may further communicate with a database 150.

The server 140 contains instruction sets governing how clients may interface with their camera units and serves a plurality of user devices 110 having associated user accounts 102. The database 150 may contain user account information, payment information, uploaded image data from the camera units, and information about associated traps.

In some examples, a user may be able to remotely instruct a selected camera unit 200 to capture image data and upload it to the platform for viewing by the user through their user device, allowing the status of monitored animal traps in remote locations to be viewed on demand without the need for a constant upload stream.

A user may also be able to force the camera unit 200 and corresponding trap activation unit to enter a low power sleep mode via the platform interface.

The foregoing are merely illustrative of the architecture of the Animal Monitoring Platform system 100 and is not meant to be limiting.

Each user device 110 may include conventional software such as productivity tools (e.g., word processing, spreadsheets, etc.) and at least one browser. Tablet computer 113 or smartphone 114 may also include at least one “app” (defined generally as a purpose-oriented application that may include network communications as part of the functionality), as well as a biometric sensor 116 that can be a conventional optical scanner configured with an appropriate app for use as a fingerprint reader. The fingerprint reader may include software for receiving data from the scanner and interpreting the data within the context of a fingerprint. Other user devices 110 may include a biometric sensor 116 and/or other equipment useful for implementing authentication schemes. Thus, the Animal Monitoring Platform system may implement security measures for ensuring the appropriate user is accessing their platform account.

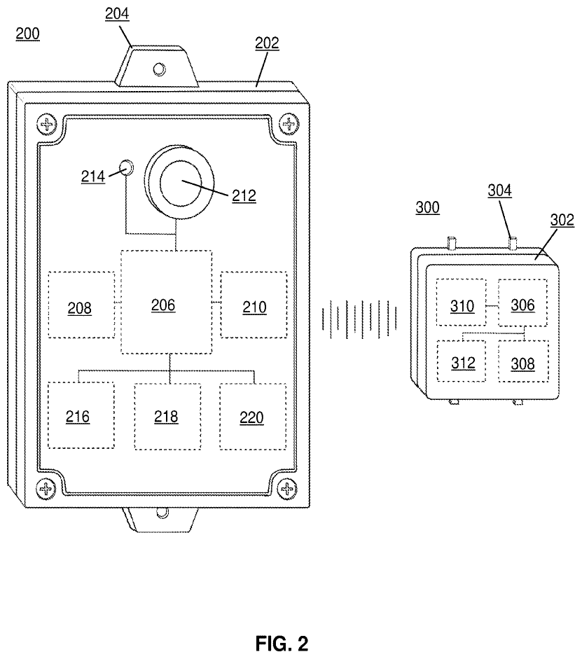

Referring to FIG. 2, an example of a paired camera unit 200 and trap activation unit 300 are shown in greater detail including functional blocks of the internal circuitry components shown by dashed lines.

The camera unit 200 comprises a housing 202 for holding the internal components (preferably waterproof given that the unit will likely be installed in outdoor areas often), and securing means 204 for affixing the unit in place with a view of an animal trap.

The camera unit is controller by a microcontroller 206 powered by a power source such as a rechargeable battery and coupled to a wireless transceiver 210 having the functionalities listed above with reference to FIG. 1 for communicating with the servers of the network. The microcontroller may for example be a smart chip processor.

A digital camera 212 is installed in the unit and controlled by microcontroller 210. A lighting element 214 may also be provided capable of illuminating an area on which the digital camera 212 is focused with a high power flash.

The camera unit 200 may also be provided with a GPS unit 216, allowing the controller 206 to upload accompanying location data alongside captured image data to the online platform. Furthermore, additional sensors may be provided in the camera unit 200 such as a motion sensor 218 and magnetic field sensor 220. The motion sensor may be, for example, a vibration sensor and/or an IR sensor. Having these functionalities facilitates use of the camera unit as a standalone trap monitoring device when desired.

Each camera unit 200 is paired with a smaller trap activation unit 300. Similarly to the camera units, the trap activation units 300 each comprise a waterproof housing 302 and securing means 304 such as in the present example a clip, allowing the units to be installed on or in close proximity to an animal trap.

The trap activation units 300 have a smaller controller 306 with basic processing capabilities and powered by their own power source 308—for example a button battery, and also a wireless transceiver 310 capable of short range communications such as Bluetooth so that the units can pair with and remain in communication with a corresponding camera unit 300.

The trap activation units 300 are also each equipped with one or more sensors 312. The sensors 312 include at a minimum a motion sensor for detecting movement of animals in close proximity to a monitored trap, but may also comprise a magnetic field sensor that can be paired with a permanent magnet installed on a part of the monitored trap that moves when it is triggered. For example, the permanent magnet may be installed on the closing door of a trap while the trap activation unit is installed on a side wall.

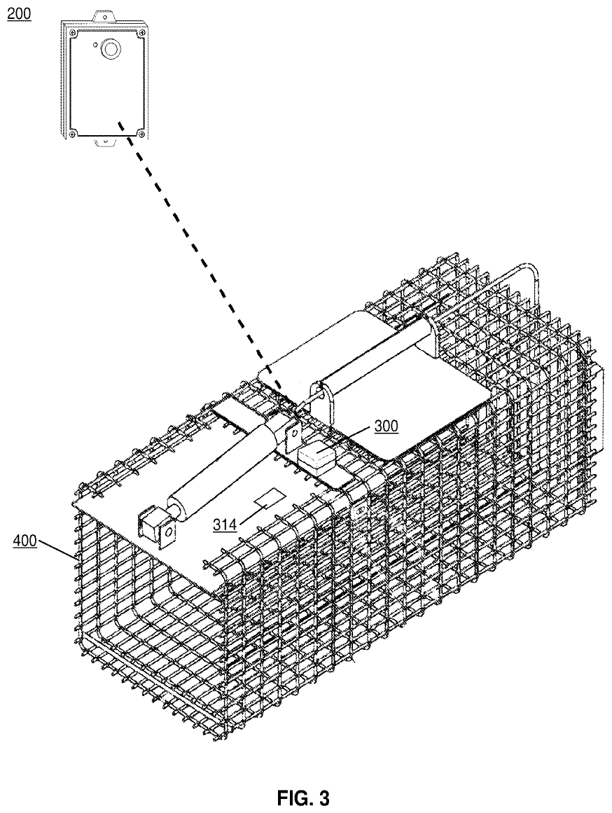

Referring to FIG. 3, an example installation of a paired camera unit 200 and trap activation unit 300 on a trap 400 is shown, with a permanent magnet 314 installed on the moving door of the trap 400 and the trap activation unit 300 installed on an unmoving part.

The motion detected by the motion sensor or the change in magnetic field detected when the permanent magnet moves relative to the unit can each serve as a trigger for generating an alert or notification. The controller 306 of each trap activation unit is then configured to send the alert/notification to a paired camera unit 200 in response to such a trigger, causing image data of the monitored trap to be taken and uploaded to the online platform so that a user can check what kind of activity has occurred for the monitored trap without physically visiting.

A user may utilise the online platform to remotely select the mode of operation of each pair of camera unit and trap activation sensor: standalone camera unit mode, where only the sensors of the camera unit trigger image capture, motion sensing mode, where only the motion sensor of the trap activation unit triggers image capture, or magnet mode, where only movement of the permanent magnet triggers image capture.

In other examples the magnetic sensors of the two units may be used to turn them on or initialise them. The devices may also be paired by other ways including standard Bluetooth pairing operations, such that any camera unit can be paired with any trap activation unit. Indeed, multiple trap activation units may be paired with the same camera unit or vice versa.

The camera unit and trap activation sensor can be installed to monitor animal activity in various ways, not only in the configuration shown in FIG. 3.

For example, the motion sensing of the camera unit may be employed at a point of ingress/narrow space which an animal such as a rodent is expected to or has been encouraged to traverse to gain a better picture of the levels of activity on a site.

The trap activation unit may also be installed on other types of traps such as traditional rodent snap traps.

It should be understood that the operations described herein may be carried out by any processor. In particular, the operations described above in relation to the one or more servers of the network may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the animal trap monitoring system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for monitoring an animal trap, the system comprising:
a camera unit, the camera unit comprising: a power source; a digital camera; a first wireless communications module; and a first controller;
a trap activation unit, the trap activation unit comprising: a power source;
one or more sensors; securing means for affixing the unit in place upon, or in close proximity to, an animal trap; a second wireless communications module; and a second controller paired with and in wireless communication with the first controller;
one or more servers configured to receive and store image data from the camera unit and further configured to host an online platform for interfacing with the camera unit via one or more user devices;
wherein the second controller is configured to generate and send a notification or alert to the first controller in response to a detection of a signal from the one or more sensors indicative of animal activity;
and wherein the first controller is configured to, in response to receiving a notification or alert from the second controller, capture image data of an animal trap with the digital camera and upload the image data to the one or more servers.

2. A system according to claim 1, wherein the one or more servers are configured to allow a user accessing the hosted online platform to remotely instruct the camera unit to capture image data and upload it to the platform for viewing on demand.

3. A system according to claim 1, wherein the camera unit further comprises one or more additional sensors.

4. A system according to claim 3, wherein the additional sensors include a motion sensor in the form of a vibration sensor and/or an infra-red, IR sensor, and the first controller is configured to capture and upload image data in response to a detection of motion in proximity to the camera unit.

5. A system according to claim 3, wherein the additional sensors include a magnetic field sensor.

6. A system according to claim 5, wherein the magnetic field sensor is paired with a permanent magnet and the first controller is configured to capture and upload image data in response to a detection of a change in magnetic field strength detected from the permanent magnet.

7. A system according to claim 3, wherein the one or more servers are configured to allow a user accessing the platform to instruct the first controller on whether to trigger the capture of image data based on the trap activation sensor or using a sensor of the one or more additional sensors.

8. A system according to claim 1, wherein the camera unit further comprises a flash lighting element configured to illuminate an area at which the digital camera is focused to facilitate capture of image data.

9. A system according to claim 1, wherein the paired wireless communications modules of the camera unit and trap activation unit communicate via Bluetooth.

10. A system according to claim 9, wherein the wireless communications module of the camera unit is further configured for satellite and 4G wireless standards to communicate with the one or more servers.

11. A system according to claim 1, wherein the camera unit further comprises a GPS unit, and is configured to upload location data to the one or more servers alongside the image data.

12. A system according to claim 1, wherein the components of the camera unit are disposed within a waterproof housing.

13. A system according to claim 1, wherein the camera unit comprises securing means for affixing it in place with a view of an animal trap and surrounding environment.

14. A system according to claim 1, wherein the second controller is configured with one or more predefined thresholds and/or filter algorithms for preventing false alert notifications from being sent to the first controller.

15. A system according to claim 1, wherein the one or more servers are configured to allow a user to remotely deactivate the camera unit, putting it into a low power sleep mode.

16. A system according to claim 1, wherein the system further comprises one or more additional pairs of camera units and trap activation units in communication with the one or more servers.
